(19) United States
(12) Patent Application Publication
(10) Pub. No.: US 2008/0260110 A1
(43) Pub. Date: Oct. 23, 2008

(54) Checking Whether a Public Safety Answering Point (PSAP) is Correctly Associated with an Endpoint

(76) Inventors: Ashish P. Chotai, Santa Clara, CA (US); Sravan Vadlakonda, Sunnyvale, CA (US); Aseem B. Asthana, San Jose, CA (US); James M. Polk, Colleyville, TX (US); Cullen F. Jennings, San Jose, CA (US)

Correspondence Address: BAKER BOTTS L.L.P., 2001 ROSS AVENUE, SUITE 600, DALLAS, TX, 75201-2980, US

(21) Appl. No.: 11/738,001

(22) Filed: Apr. 20, 2007

(51) Int. Cl. H04M 11/04

(52) U.S. Cl. 379/45

(57) ABSTRACT

In one embodiment, a method includes automatically detecting occurrence of an event at an endpoint that suggests checking whether a public safety answering point (PSAP) currently associated with the endpoint is correctly associated with the endpoint. The method further includes, in response to the occurrence of the event, automatically prompting through the endpoint a user to provide input indicating whether data identifying a current location of the endpoint is correct. The method further includes receiving input from the user through the endpoint indicating whether the data is correct and, if the input from the user indicates that the data is not correct, automatically initiating an update of the data to correctly identify the current location of the endpoint.

### TECHNICAL FIELD

The present disclosure relates generally to communication networks.

### BACKGROUND

Different PSAPs typically serve different geographical areas. A service provider supporting a voice over Internet Protocol (VoIP) endpoint typically routes emergency calls from the VoIP endpoint to a PSAP according to information that the user provides when the user purchases the VoIP endpoint. For example, when the user purchases the VoIP endpoint, the user may provide an address to the service provider. The service provider may route emergency calls from the VoIP endpoint to a PSAP that serves the address provided by the user. As long as the VoIP endpoint remains at or near the address provided by the user, emergency calls from the VoIP endpoint may route to a PSAP that serves a current location of the endpoint. However, if the user moves the VoIP endpoint away from the address provided by the user, emergency calls from the VoIP endpoint may route to a PSAP that does not serve a current location of the endpoint.

### BRIEF DESCRIPTION OF THE DRAWINGS

FIG. 1 illustrates an example system for checking whether a PSAP is correctly associated with an endpoint; and

FIG. 2 illustrates an example method for checking whether a PSAP is correctly associated with an endpoint.

### DESCRIPTION OF EXAMPLE EMBODIMENTS

Overview

In one embodiment, a method includes automatically detecting occurrence of an event at an endpoint that suggests checking whether a public safety answering point (PSAP) currently associated with the endpoint is correctly associated with the endpoint. The method further includes, in response to the occurrence of the event, automatically prompting through the endpoint a user to provide input indicating whether data identifying a current location of the endpoint is correct. The method further includes receiving input from the user through the endpoint indicating whether the data is correct and, if the input from the user indicates that the data is not correct, automatically initiating an update of the data to correctly identify the current location of the endpoint.

Description

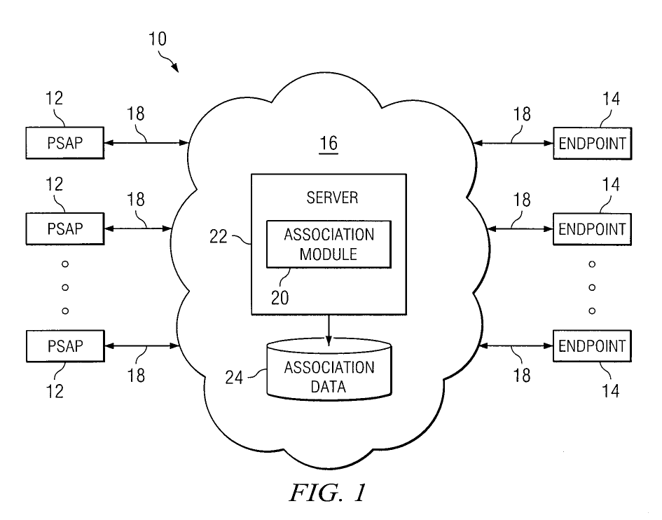

FIG. 1 illustrates an example system 10 for checking whether a PSAP 12 is correctly associated with an endpoint 14. System 10 includes PSAPs 12 and endpoints 14. A PSAP 12 communicates with an endpoint 14 via network 16. In particular embodiments, network 16 is a local area network (LAN), a wireless LAN (WLAN), a wide area network (WAN), a metropolitan area network (MAN), a portion of the Internet, a portion of the Public Switched Telephone Network (PSTN), or another network 16 or a combination of two or more such networks 16. The present disclosure contemplates any suitable network 16 or combination of networks 16. One or more links 18 couple an endpoint 14 to network 16. Similarly, one or more links 18 couple a PSAP 12 to network 16. In particular embodiments, one or more links 18 each include one or more wireline, wireless, or optical links 18. In particular embodiments, one or more links 18 each include a LAN, a WLAN, a WAN, a MAN, a portion of the Internet, a portion of the PSTN, or another link 18 or a combination of two or more such links 18. The present disclosure contemplates any suitable links 18 coupling endpoints 14 and PSAPs 12 to network 16.

PSAPs 12 answer emergency calls from endpoints 14. As an example and not by way of limitation, PSAPs 12 may answer E911 calls from endpoints 14. In response to an E911 call from an endpoint 14 to a PSAP 12, an agent at PSAP 12 may contact and direct one or more emergency responders (such as, for example, police officers, firemen, emergency medical technicians (EMTs), etc.) as needed to respond to an emergency reported by a user at endpoint 14. In particular embodiments, different PSAPs 12 serve different geographical areas. As an example and not by way of limitation, a first PSAP 12 located in San Jose, Calif., may be able to contact and direct emergency responders in or near San Jose, but be unable to contact and direct emergency responders outside San Jose and nearby areas. Similarly, a second PSAP 12 located in Dallas, Tex., may be able to contact and direct emergency responders in or near Dallas, but be unable to contact and direct emergency responders outside Dallas and nearby areas. In particular embodiments, if an emergency call from an endpoint 14 routes to a PSAP 12 that does not serve a geographical area that includes a current location of endpoint 14, the agent who answers the emergency call will likely be unable to initiate a response to an emergency reported by a user at endpoint 14. Therefore, proper routing of emergency calls from endpoints 14 to PSAPs 12 is an important part of effective emergency response. In particular embodiments, a governmental regulatory entity (such as, for example, the Federal Communications Commission (FCC)) having regulatory authority over one or more service providers owning or operating one or more portions of system 10 mandates that the service providers are responsible for correctly routing emergency calls.

Endpoints 14 enable users at endpoints 14 to communicate with PSAPs 12 and other endpoints 14. As an example and not by way of limitation, an endpoint 14 may include an analog telephone coupled to an analog telephone adapter (ATA), a landline telephone that has VoIP capabilities, a mobile telephone that has VoIP capabilities, a personal digital assistant (PDA), a computer system, or another endpoint 14 or a combination of two or more such endpoints 14. An analog telephone may be a landline telephone set that may generate dual-tone multifrequency (DTMF) signals in response to a user pressing keys on the telephone set. A telephone having VoIP capabilities may be an Internet Protocol (IP) telephone that may generate data providing DTMF signals in response to a user pressing keys on the telephone or otherwise providing input to the telephone. A mobile telephone may be a wireless telephone capable of connecting to an 802.11 or other WLAN, a cellular telephone network, or both. A computer system may be a notebook computer system capable of connecting to an LAN, a WLAN, or both. To communicate with one or more other users, a user at a computer system coupled to network 16 may access a telephone application on the computer system. The present disclosure contemplates any suitable endpoints 14.

In particular embodiments, an endpoint 14 is moveable from one location to another. As an example and not by way of limitation, a user may move an ATA from a first address to a second address. A first PSAP 12 may serve a first geographical area that includes the first address but not the second address, and a second PSAP 12 may serve a second geographical area that includes the second address but not the first address. If the user makes an emergency call from the ATA at the second address and the emergency call routes to first PSAP 12 instead of second PSAP 12, the emergency call will likely reach an agent who is unable to initiate a response to an emergency reported by the user.

In particular embodiments, to route an emergency call from an endpoint 14, a service provider supporting endpoint 14 identifies a PSAP 12 associated with endpoint 14 and routes the emergency call to PSAP 12 via network 16. As an example and not by way of limitation, when a user at endpoint 14 places an emergency call, the service provider may access data indicating a location of endpoint 14, identify a PSAP 12 that serves a geographical area that includes the indicated location of endpoint 14, and route the emergency call to PSAP 12. If the data indicating the location of endpoint 14 is correct, PSAP 12 may serve a geographical area that includes the location of endpoint 14 at the time of the emergency call. On the other hand, if the data indicating the location of endpoint 14 is incorrect, PSAP 12 may serve a geographical area that excludes the location of endpoint 14 at the time of the emergency call. As a result, if the data indicating the location of endpoint 14 is incorrect, the emergency call may reach an agent who is unable to initiate a response to an emergency reported by the user.

In particular embodiments, data indicating a location of an endpoint 14 typically comes from information provided by a user when the user purchased endpoint 14. As an example and not by way of limitation, when a user purchases an endpoint 14, the user may fill out a form made available by a service provider asking for the address of the user. The user may fill out the form and return it to the service provider, and the service provider may store the address of the user and use the same to indicate the location of endpoint 14 for purposes of routing emergency calls from endpoint 14. If endpoint 14 is at or near the address on the form when the user makes an emergency call from endpoint 14, the emergency call may route to a PSAP 12 that serves a current location of endpoint 14. On the other hand, if endpoint 14 is away from the address on the form when the user makes an emergency call from endpoint 14, the emergency call may route to a PSAP 12 that does not serve a current location of endpoint 14. Endpoint 14 may, at the time of the emergency call, be away from the address on the form, e.g., as a result of the user having moved to a new city after filling out the form and returning the form to the service provider.

In particular embodiments, system 10 includes an association module 20 residing at a server 22 in network 16. In particular embodiments, association module 20 includes one or more association modules 20 and server 22 includes one or more servers 22. In particular embodiments, association module 20 is a hardware, software, or embedded logic component or a combination of two or more such components that collectively provide functionality for checking whether a PSAP 12 currently associated with an endpoint 14 is correctly associated with endpoint 14, as described below. In particular embodiments, one or more association modules 20 reside at one or more endpoints 14 in system 10. As an example and not by way of limitation, an association module 20 may reside at an ATA in an endpoint 14 that includes an analog telephone coupled to the ATA. Emergency calls from an endpoint 14 associated with a PSAP 12 route to PSAP 12. An endpoint 14 is correctly associated with a PSAP 12 if PSAP 12 serves a geographical area that includes a current location of endpoint 14, and an endpoint 14 is incorrectly associated with a PSAP 12 if PSAP 12 serves a geographical area that excludes a current location of endpoint 14.

In particular embodiments, server 22 includes a hardware, software, or embedded logic component or a combination of two or more such components that collectively facilitate routing emergency calls from endpoints 12 to PSAPs 14. Server 22 has access to association data 24, which includes data indicating associations between PSAPs 12 and endpoints 14. As an example and not by way of limitation, association data 24 may include data indicating locations of endpoints 14. Association data 24 may include data indicating geographical areas served by PSAPs 12. Association data 24 may include data specifying a PSAP 12 for each endpoint 14. The present disclosure contemplates association data 24 including any suitable data. In particular embodiments, to facilitate routing an emergency call from an endpoint 14 to a PSAP 12, server 22 accesses association data 24 indicating a PSAP 12 associated with endpoint 14 and causes the emergency call to route to PSAP 12. As an example and not by way of limitation, a user at an endpoint 14 may make an emergency call and server 22 may detect the emergency call. Server 22 may access association data 24 and determine, according to association data 24, a location of endpoint 14. Server 22 may then determine a PSAP 12 serving a geographical area including the location of endpoint 14 and cause the emergency call to route to PSAP 12.

As described above, association module 20 checks whether a PSAP 12 currently associated with an endpoint 14 is correctly associated with endpoint 14. In particular embodiments, association module 20 detects the occurrence of one or more events and, in response to one or more of the events, automatically checks whether a PSAP 12 currently associated with an endpoint 14 is correctly associated with endpoint 14. As an example and not by way of limitation, association module 20 may automatically check whether PSAP 12 is correctly associated with endpoint 14 in response to a predetermined amount of time lapsing (such as, for example, three months) since association module 20 last checked whether PSAP 12 was correctly associated with endpoint 14. As another example, association module 20 may automatically check whether PSAP 12 is correctly associated with endpoint 14 in response to one or more components at endpoint 14 rebooting. As another example, association module 20 may automatically check whether PSAP 12 is correctly associated with endpoint 14 in response to one or more components at endpoint 14 powering up. As another example, association module 20 may automatically check whether PSAP 12 is correctly associated with endpoint 14 in response to an IP address of endpoint 14 changing. As another example, association module 20 may automatically check whether PSAP 12 is correctly associated with endpoint 14 in response to an endpoint 14 establishing a connection to a new 802.11 access point (AP). The present disclosure contemplates association module 20 automatically checking whether a PSAP 12 currently associated with an endpoint 14 is correctly associated with endpoint 14 in response to any suitable event.

In particular embodiments, to check whether a PSAP currently associated with an endpoint 14 is correctly associated with endpoint 14, association module 20 prompts, through endpoint 14, a user to verify a current location of endpoint 14 indicated by association data 24. As an example and not by way of limitation, association module 20 may cause a remote server to communicate an audio file to endpoint 14 for endpoint 14 to play to a user at endpoint 14. Endpoint 14 may automatically play the audio file to the user when the user takes endpoint 14 off hook. The audio file may communicate to the user, “Emergency calls from your phone will go to San Jose, Calif. If you are in fact in San Jose, Calif., please press the star key to confirm. If you are not in San Jose, Calif., please press the pound key to initiate an update of your current location.” If the user presses the star key, endpoint 14 may communicate to association module 20 data confirming that the current location of endpoint 14 indicated by association data 24 is correct. If the user presses the pound key, endpoint 14 may connect to an interactive voice response (IVR) module at server 22 or elsewhere in network 16 and the IVR module may solicit input from the user indicating the current location of endpoint 14. The IVR module may communicate the input from the user to association module 20, and association module 20 may update association data 24 accordingly. As an alternative, if the user presses the pound key, endpoint 14 may connect to an agent at a contact center who may communicate with the user, determine the current location of endpoint 14, and update association data 24 accordingly.

As another example, to check whether a PSAP currently associated with an endpoint 14 is correctly associated with endpoint 14, association module 20 may cause a remote server to call endpoint 14 and initiate an IVR session with a user when the user answers the call. The remote server may determine through the IVR session whether the current location of endpoint 14 indicated by association data 24 is correct. If the remote server determines that the current location of endpoint 14 indicated by association data 24 is correct, the remote server may communicate to association module 20 data confirming that the current location of endpoint 14 indicated by association data 24 is correct. If the remote server determines that the current location of endpoint 14 indicated by association data 24 is incorrect, remote server may solicit input from the user indicating the current location of endpoint 14. The remote server may communicate the input from the user to association module 20, and association module 20 may update association data 24 accordingly.

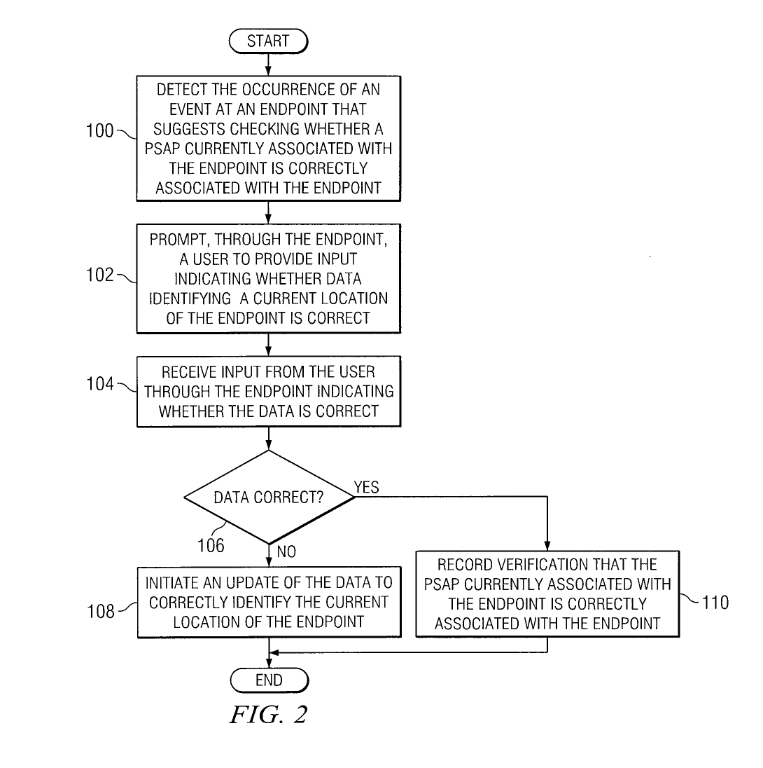

FIG. 2 illustrates an example method for checking whether a PSAP is correctly associated with an endpoint. The method begins at step 100, where association module 20 detects the occurrence of an event at an endpoint 14 that suggests checking whether a PSAP 12 currently associated with endpoint 14 is correctly associated with endpoint 14. At step 102, association module 20 (possibly together with one or more other components in network 16) prompts, through endpoint 14, a user to provide input indicating whether association data 24 identifying a current location of endpoint 14 is correct. At step 104, association module 20 receives input from the user through endpoint 14 indicating whether association data 24 identifying a current location of endpoint 14 is correct. At step 106, if association data 24 identifying a current location of endpoint 14 is correct, the method proceeds to step 108. At step 108, association module 20 initiates an update of association data 24 to correctly identify the current location of endpoint 14, at which point the method ends. Returning to step 106, if association data 24 identifying a current location of endpoint 14 is incorrect, the method proceeds to step 110. At step 110, association module 20 records a verification that PSAP 12 currently associated with endpoint 14 is correctly associated with endpoint 14, at which point the method ends. Although particular components have been illustrated and described as carrying out particular steps of the method illustrated in FIG. 2, the present disclosure contemplates any suitable components carrying out any suitable steps of the method illustrated in FIG. 2. Moreover, Although particular steps of the method illustrated in FIG. 2 have been illustrated and described as occurring in a particular order, the present disclosure contemplates any suitable steps of the method illustrated in FIG. 2 occurring in any suitable order.

The present disclosure encompasses all changes, substitutions, variations, alterations, and modifications to the example embodiments described herein that a person having ordinary skill in the art would comprehend. Similarly, where appropriate, the appended claims encompass all changes, substitutions, variations, alterations, and modifications to the example embodiments described herein that a person having ordinary skill in the art would comprehend.

What is claimed is:

1. A method comprising:
automatically detecting occurrence of an event at an endpoint that suggests checking whether a public safety answering point (PSAP) currently associated with the endpoint is correctly associated with the endpoint;
in response to the occurrence of the event, automatically prompting through the endpoint a user to provide input indicating whether data identifying a current location of the endpoint is correct;
receiving input from the user through the endpoint indicating whether the data is correct; and
if the input from the user indicates that the data is not correct, automatically initiating an update of the data to correctly identify the current location of the endpoint.

2. The method of claim 1, wherein the endpoint comprises an analog telephone adapter (ATA) and a telephone coupled to the ATA.

3. The method of claim 2, executed at the ATA.

4. The method of claim 1, wherein the input from the user is a voice response provided by the user.

5. The method of claim 1, wherein the event comprises a default, but configurable, interval of time elapsing.

6. The method of claim 1, wherein the event comprises one or more components of the endpoint rebooting.

7. The method of claim 1, wherein the event comprises one or more components of the endpoint powering up.

8. The method of claim 1, wherein the event comprises an Internet Protocol (IP) address of one or more components of the endpoint changing.

9. The method of claim 1, wherein the prompt comprises an audible indication, through the endpoint, of the current location of the endpoint identified by the data.

10. The method of claim 1, wherein automatically prompting the user comprises playing to the user through the endpoint an audio file communicated to the endpoint from a remote server, the remote server having communicated the audio file to the endpoint in response to detection of the occurrence of the event at the endpoint.

11. The method of claim 1, wherein the prompt comprises a request for confirmation from the user of the current location of the endpoint identified by the data.

12. The method of claim 1, wherein prompting the user and receiving input from the user occur in a telephone call from a remote server to the endpoint initiated in response to detection of the occurrence of the event at the endpoint.

13. An apparatus comprising:
one or more processors; and
a memory coupled to the processors comprising instructions executable by the processors, the processors operable when executing the instructions to:
automatically detect occurrence of an event at an endpoint that suggests checking whether a public safety answering point (PSAP) currently associated with the endpoint is correctly associated with the endpoint;
in response to the occurrence of the event, automatically prompt through the endpoint a user to provide input indicating whether data identifying a current location of the endpoint is correct;
receive input from the user through the endpoint indicating whether the data is correct; and
if the input from the user indicates that the data is not correct, automatically initiate an update of the data to correctly identify the current location of the endpoint.

14. The apparatus of claim 13, wherein the endpoint comprises an analog telephone adapter (ATA) and a telephone coupled to the ATA.

15. The apparatus of claim 14, wherein the apparatus is the ATA.

16. The apparatus of claim 13, wherein the input from the user is a voice response provided by the user.

17. The apparatus of claim 13, wherein the event comprises a default, but configurable, interval of time elapsing.

18. The apparatus of claim 13, wherein the event comprises or more components of the endpoint rebooting.

19. The apparatus of claim 13, wherein the event comprises one or more components of the endpoint powering up.

20. The apparatus of claim 13, wherein the event comprises an Internet Protocol (IP) address of one or more components of the endpoint changing.

21. The apparatus of claim 13, wherein the prompt comprises an audible indication, through the endpoint, of the current location of the endpoint identified by the data.

22. The apparatus of claim 13, wherein automatically prompting the user comprises playing to the user through the endpoint an audio file communicated to the endpoint from a remote server, the remote server having communicated the audio file to the endpoint in response to detection of the occurrence of the event at the endpoint.

23. The apparatus of claim 13, wherein the prompt comprises a request for confirmation from the user of the current location of the endpoint identified by the data.

24. The apparatus of claim 13, wherein prompting the user and receiving input from the user occur in a telephone call from a remote server to the endpoint initiated in response to detection of the occurrence of the event at the endpoint

25. Logic encoded in one or more tangible media for execution and when executed operable to:
automatically detect occurrence of an event at an endpoint that suggests checking whether a public safety answering point (PSAP) currently associated with the endpoint is correctly associated with the endpoint;
in response to the occurrence of the event, automatically prompt through the endpoint a user to provide input indicating whether data identifying a current location of the endpoint is correct;
receive input from the user through the endpoint indicating whether the data is correct; and
if the input from the user indicates that the data is not correct, automatically initiate an update of the data to correctly identify the current location of the endpoint.
